(19) United States
(12) Patent Application Publication
(10) Pub. No.: US 2007/0104133 A1
(43) Pub. Date: May 10, 2007

(54) Method for improved frequency division duplex operation in a wireless communications system

(76) Inventors: Jim Jingfu Chao, Naperille, IL (US); Subramanian Vasudevan, Morristown, NJ (US); Jialin Zou, Randolph, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/271,385

(22) Filed: Nov. 10, 2005

(51) Int. Cl. H04Q 7/00

(52) U.S. Cl. 370/329

(57) ABSTRACT

In a frequency division duplex wireless communications system, the wireless network independently and separately assigns RL and FL carrier frequencies to a mobile station, thereby supporting a variable duplex frequency separation. The assigned RL and FL carrier frequencies can be within the same frequency segment, in different frequency segments within a band class, or can be in different band classes. This feature is supported by new channel mapping and signaling.

### TECHNICAL FIELD

This invention relates to wireless communication, and more particularly to frequency division duplex operation of a wireless communications system.

### BACKGROUND OF THE INVENTION

In accordance with current practices, the FCC sells wireless service providers complementary blocks of spectrum in different frequency segments that are, for example, within the 800 MHz band class, the 1.9 GHz band class, or other band classes. Each such purchased block of spectrum within a frequency segment in the 800 MHz band class, for example, is separated from its complementary block of spectrum in another frequency segment within that same band class by a fixed constant frequency. One of the complementary blocks of spectrum purchased by a wireless service provider is used for forward link (FL) transmissions (from the wireless network to a mobile terminal), and the other complementary block is used for reverse link (RL) transmissions (from the mobile terminal to the wireless network). FIG. 1 shows a prior art arrangement in which a frequency segment 101 between approximately 824 MHz and 848 MHz in the 800 MHz band class is used for RL transmissions and frequency segment 102 between approximately 869 MHz and 893 MHz within that same band class is used for FL transmissions. Various frequency blocks of different widths make up each frequency segment with each in block segment 101 that is used for RL transmissions having a complementary block in segment 102 that is used for FL transmission. In the 800 MHz band class there is a fixed separation of 45 MHz between all complementary blocks. A service provider might own complementary blocks 103 and 104, for example, in frequency segments 101 and 102, respectively, within the 800 MHz band class with that fixed separation of 45 MHz between those blocks.

In frequency division duplex (FDD) systems that are in accord with wireless standards such as CDMA2000 3G1X and CDMA2000 1xEVDO, a channel is dynamically assigned for communications between the base station and the mobile terminal. That channel consists of a specific 1.25 MHz-wide channel within the service provider's owned block within the frequency segment that is reserved for FL transmissions and a corresponding 1.25 MHz-wide channel in the service provider's owned complementary block within the frequency segment within the same band class that is reserved for RL transmissions. Since the corresponding blocks within a frequency segment that the service provider owns are separated by a fixed frequency, each pair of 1.25 MHz-wide FL and RL channels that are dynamically assigned to a mobile terminal are separated by that same fixed frequency, which in the 800 MHz band class is 45 MHz as noted above. In dynamically assigning channels to a mobile terminal for transmission and reception, the specific channels that are dynamically assigned by the network to the mobile for RL and FL transmissions and receptions, respectively, can be assigned by means of a single channel number that is mapped to a specific RL and FL duplex pair.

The FCC released new spectrum blocks at 2.5 GHZ for wireless services. As shown in FIG. 2, a proposed new band class that can be used for providing wireless services such as CDMA2000 1xEVDO will consist of four 16.5 MHz-wide blocks 201, 202, 203, and 204, in the frequency segment 205 between 2502 MHz and 2568 MZ, and four 16.5 MHz-wide blocks 206, 207, 208, and 209, in the frequency segment 210 between 2624 MHz and 2690 MHz. Unlike the frequency allocations in the 800 MHz band class, a service provider who purchases a block in the 2.5 GHz band class within one segment may not always own a corresponding complementary block in the other segment. Furthermore, the blocks owned by a service provider in one coverage area might not correspond to the blocks owned by that same service provider in a different coverage area. For example, in one coverage area a service provider might own block 201 in frequency segment 205 and own block 209 in frequency segment 210, while in another coverage area, that same service provider might own block 204 in frequency segment 205 and own block 206 in frequency segment 210. With such an arrangement, the frequency separation between an assigned FL channel in one segment and the corresponding RL channel in the other segment is not constant and may differ from coverage area-to-coverage area. Assignment of FL and RL channels will no longer be able to be supported since the relationship between the assigned FL and RL channel frequencies is unknown. Further, with such coverage area-dependent channel separations, when a mobile terminal moves between coverage areas having different frequency separations between the RL and FL channels, the mobile terminal will not be able to adjust to the changed FL and RL carrier frequencies.

### SUMMARY OF THE INVENTION

In accordance with an embodiment of the present invention, the wireless network independently and separately assigns RL and FL carrier frequencies to a mobile station, thereby supporting a variable duplex frequency separation. The assigned RL and FL carrier frequencies can be within the same frequency segment, in different frequency segments within a band class, or can even be in different band classes. Advantageously, by providing the ability to separately assign the RL and FL channels to a mobile station, more flexible spectrum allocation at different service coverage area will be supported. In addition, if an overload condition or degraded channel quality is detected on only one channel (either a FL or RL channel) and the other corresponding channel is not similarly afflicted, the overloaded or degraded channel can be independently switched to another frequency without needing to change the other corresponding channel away from where it is operating successfully. This is unlike the prior art where detection of an overloaded or degraded channel RL or FL channel results in the switching of both channels to a new pair of frequencies.

In an exemplary embodiment of the present invention in a system operating in accordance with CDMA2000 1xEVDO standards, when an origin base transceiver station (BTS) within a radio access network (RAN) receives a route update message (RUM) from a mobile station (MS) indicating that it is about to move into the coverage area of target BTS, the origin BTS sends the MS a traffic channel assignment (TCA) message that provides the MS with independent channel numbers corresponding to specific frequency channels to be used for RL and FL transmissions when communicating with the target BTS.

### BRIEF DESCRIPTION OF THE DRAWING

FIG. 1 shows the prior art arrangement of frequency blocks within corresponding frequency segments as currently arranged in the 800 MHz and 1.9 GHz band classes;

FIG. 2 shows an exemplary arrangement of frequency blocks within frequency segments in a proposed 2.5 GHz band class; and

FIG. 3 is a block diagram of an exemplary wireless network operating in accordance with CDMA2000 1xEVDO standards to which an embodiment of the present invention is applied.

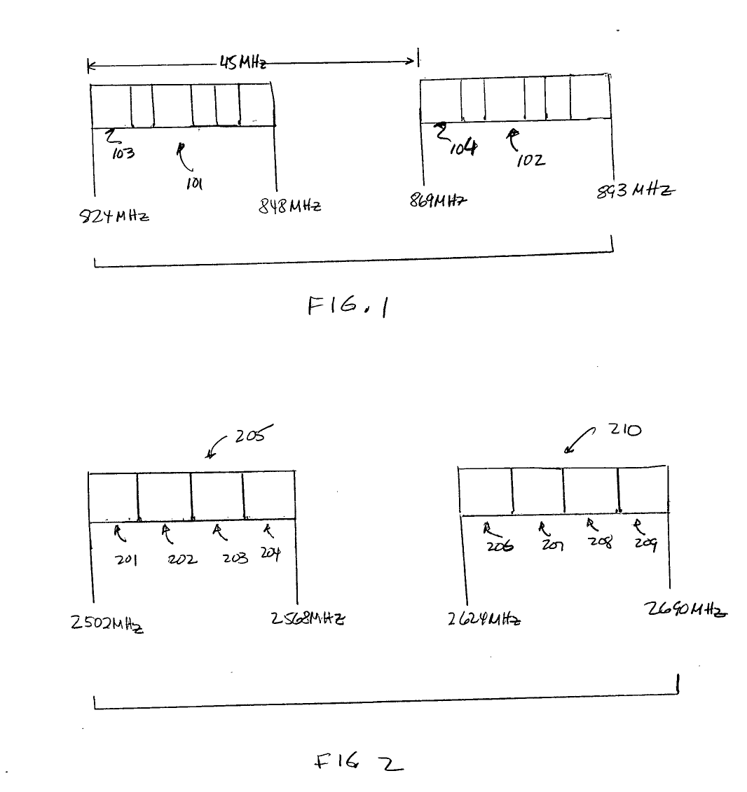

### DETAILED DESCRIPTION

The exemplary wireless network shown in FIG. 3 is in accord with CDMA2000 1xEVDO standards. This digital data network supports voice-over-IP (VoIP), the downloading of high-speed data and conversational video, uploading of digital pictures, etc. Using terminology commonly associated with these standards, RAN 301 includes a radio network controller (RNC) 302, which is connected to multiple BTSs, illustratively shown as BTS 303 and BTS 304. The RNC 302 is connected to a packet data switching node (PDSN) 305, which in turn is connected to a packet network 306 such as the Internet. A mobile station (MS) 307, also referred to as an access terminal (AT), is shown communicating with BTS 303. On the FL, MS 307 is communicating on a channel at frequency F1 and on the RL it is communicating on a channel at frequency F2. In accordance with this embodiment of the invention, F1 and F2 do not necessarily lay in different blocks in corresponding frequency segments within the same frequency class. They can lay within different blocks within the same frequency segment, or in different blocks that each are within different band classes. Preferably, if F1 and F2 lay within the same frequency segment, then the frequency separation between F2 and F1 is always maintained at greater than a predetermined minimum frequency duplex separation in order to prevent cross-channel interference, and as is required based on RF technology.

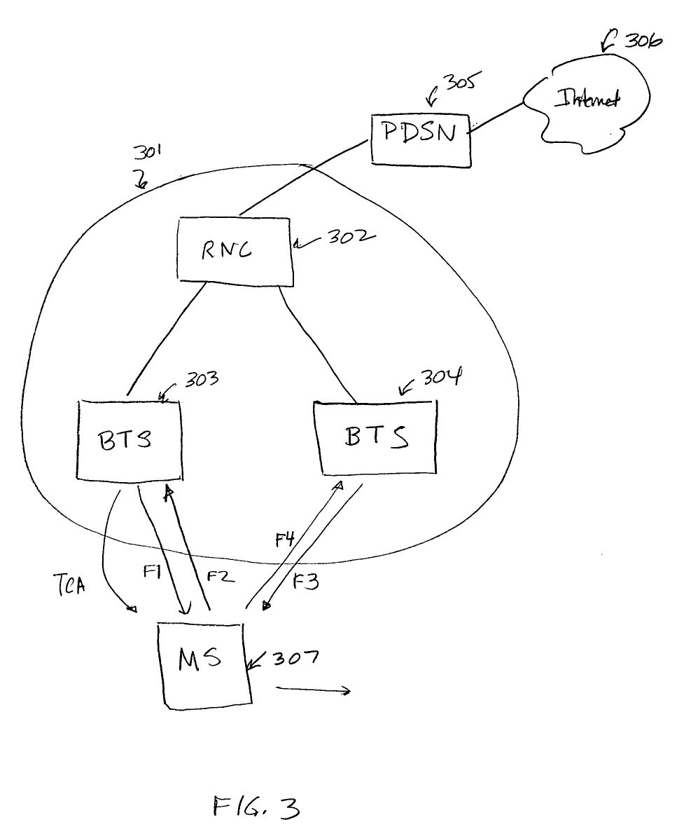

As an illustration, in the proposed 2.5 GHz class shown in FIG. 2, a service provider might own 16.5 MHz-wide blocks 201, 202 and 204 in frequency segment 205 and 16.5 MHz-wide blocks 206, 207 and 209 in frequency segment 210. In the prior art arrangement in which the frequency separation between corresponding FL and RL channels is fixed, a dynamically assigned reverse link channel within block 201 in frequency segment 205 is paired with a specific forward link channel within block 206 in frequency segment 210, where the frequency difference between these RL and FL channels is always equal to that fixed frequency separation. Similarly, a reverse link channel within block 204 in frequency segment 205 is paired with a forward link channel within block 209 in frequency segment 210 with that same fixed frequency separation between them. In embodiments of the present invention, the channels assigned to a MS for forward and reverse link transmissions have a variable frequency separation and are independently assigned. Thus, in one illustrative arrangement, channels within block 201 in frequency segment 205 that are assigned for reverse link transmissions can be paired with channels within block 209 within frequency segment 210 for forward link transmissions. Similarly, RL channels within block 207 can be paired with FL channels in block 207, and RL channels within block 204 can be paired with FL channels in block 206. In this arrangement, corresponding RL and FL channels have a variable frequency separation and lie in different frequency segments. In another arrangement, RL channels assigned in block 201 are paired with FL channels in block 203, where both blocks are within the same frequency segment 205; RL channels assigned in block 206 are paired with FL channels assigned in block 208, where both blocks are within the same frequency segment 210 (albeit separated by at least a predetermined frequency difference); and RL channels assigned in block 204 are paired with FL channels in block 2-9, where the blocks are in different frequency segments. Although not illustrated, assigned RL or FL channels within one block could be paired with FL and RL channels, respectively, in another block within a frequency segment within either the 800 MHz or 1.9 GHz band classes.

With reference again to FIG. 3, when the MS 307 moves away from BTS 303 towards BTS 304, and detects that it is going to switch from the origin BTS 303 that it is presently communicating with to a target BTS 304 from which it is receiving a stronger pilot signal, MS 307 sends a route update message (RUM) to origin BTS 303 that contains all the neighboring BTS's pilot strengths as measured by the MS. BTS 303 passes the RUM received from MS 307 to the RNC 302, which has a global view of all the BTSs to which it is connected, and which knows from that global view what carrier frequencies are available. From the BTS pilot strengths reported in this and other RUMs and from its global view of carrier availability, RNC 302 decides whether or not to allow MS 307 to switch from BTS 303 to BTS 304, and if so, onto what carriers MS 307 is to be switched. RNC 302 then sends a traffic channel assignment (TCA) message to BTS 303, which in turn sends a TCA message downlink to MS 307 telling it to move to a new link with BTS 304 and the band class(es) and separate FL and RL channel numbers, which represent the new pair of carriers frequencies, F3 and F4, on which MS 307 will respectively thereafter receive and transmit when communicating with BTS 304.

In a similar manner, while MS 307 is communicating with BTS 303, BTS 303 may locally determine that the RL carrier on which MS 307 is communicating is overloaded or if the quality of communications on that RL channel has deteriorated, even though the FL remains operative. BTS 303 will then send a TCA message to MS 307 indicating the channel number of the new RL on which it should thereafter communicate, without changing the channel number of the FL on which it has been and will continue to communicate. Thus, only the overloaded or deteriorated RL channel is switched while the FL channel remains unchanged unlike the prior art where switching either the RL or FL channel due to an overload or deteriorated condition on one channel also required switching of the complementary channel. Similarly, if the FL becomes overloaded or if the quality of communications on the FL deteriorates, the FL can be switched to another channel without switching the RL channel.

In another situation, the MS 307 could awake from a sleep mode in a region where the frequencies supported by the BTS providing service are different than those in the MS's home region or the region in which the MS was last awake. When the MS awakes, it measures the per sector carrier pilots from nearby BTSs. The MS then picks the BTS sector having the strongest pilot as the candidate BTS sector to which it should connect. The MS then listens for an initializing sectors parameters message broadcast by that BTS, which provides a specific RL channel on which the MS can send a RUM. In response to a RUM from the MS, the BTS sends a TCA message to the MS that provides separate RL and FL channel numbers that individually represent the specific RL and FL channels over which the MS should thereafter operate.

As described above, therefore, a mobile terminal is provided with information that separately specifies a RL channel and a FL channel on which to communicate when the terminal moves from one base station's coverage area to another, when it wakes up in a coverage area, and when deteriorating channel conditions or channel overloading initiate a change of one or both channels. In the described embodiment, that information is individual channel numbers that the receiving mobile terminal separately translates each into a specific frequency channels in a specific block within a specific frequency segment within a specific band class. Alternatively, that information could explicitly indicate the specific RL and FL frequencies.

Although described in conjunction with an embodiment of a wireless communications system that is operating in accordance with CDMA2000 1xEVDO standards, the present invention can be employed in any FDD communications system.

The above-described embodiments are therefore illustrative of the principles of the present invention. Those skilled in the art could devise other embodiments without departing from the spirit and scope of the present invention.

The invention claimed is:

1. A method in a frequency division duplex wireless communications system in which a mobile station receives information from an access network over a forward link and transmits information to the access network over a reverse link, the method comprising:
receiving information at the mobile station from the access network that separately and independently indicates a frequency channel to be used for the forward link and a frequency channel to be used for the reverse link.

2. The method of claim 1 wherein the information comprises channel numbers for the forward link and the reverse link that are mapped by the mobile terminal into forward link and reverse link frequency channels, respectively.

3. The method of claim 1 wherein the frequency channels to be used for the forward link and the reverse link are in different frequency segments within a band class.

4. The method of claim 1 wherein the frequency channels to be used for the forward link and the reverse link are in the same frequency segment within a band class.

5. The method of claim 4 wherein the frequency channels to be used for the forward link and the reverse link are separated by at least a predetermined frequency.

6. The method of claim 1 wherein the frequency channels to be used for the forward link and the reverse link are in different band classes.

7. The method of claim 1 wherein the information is received in an initializing sector parameter message or a traffic channel assignment message.

8. A method in a frequency division duplex wireless communications system in which a mobile station receives information from an access network over a forward link and transmits information to the access network over a reverse link, the method comprising:
transmitting information to the mobile station that separately and independently indicates a frequency channel to be used by the mobile station for the forward link and a frequency channel to be used by the mobile station for the reverse link.

9. The method of claim 8 wherein the information comprises channel numbers for the forward link and the reverse link that are mapped into forward link and reverse link frequency channels, respectively.

10. The method of claim 8 wherein the frequency channels to be used for the forward link and the reverse link are in different frequency segments within a band class.

11. The method of claim 8 wherein the frequency channels to be used for the forward link and the reverse link are in the same frequency segment within a band class.

12. The method of claim 11 wherein the frequency channels to be used for the forward link and the reverse link are separated by at least a predetermined frequency.

13. The method of claim 8 wherein the frequency channels to be used for the forward link and the reverse link are in different band classes.

14. The method of claim 8 wherein the information is transmitted in a traffic channel assignment message.
